(19) United States
(12) Patent Application Publication
(10) Pub. No.: US 2007/0240621 A1
(43) Pub. Date: Oct. 18, 2007

(54) Blast resistant composite panels for tactical shelters

(76) Inventor: Pizhong Qiao, Pullman, WA (US)

Correspondence Address: Roetzel & Andress, 222 South Main St., Akron, OH, 44308, US

(21) Appl. No.: 11/787,644

(22) Filed: Apr. 17, 2007

Related U.S. Application Data
(60) Provisional application No. 60/792,529, filed on Apr. 17, 2006.

(51) Int. Cl. E05G 1/00; F41H 5/00

(52) U.S. Cl. 109/26; 89/36.01

(57) ABSTRACT

The present invention relates to blast resistant panels. In one embodiment, the present invention relates to blast resistant panels that are designed for use in a tactical shelter. In another embodiment, to reduce the weight of a tactical shelter, a lightweight panel system is disclosed herein.

### RELATED APPLICATION DATA

This application claims priority to previously filed U.S. Provisional Application No. 60/792,529, filed on Apr. 17, 2006, entitled “Blast Resistant Composite Panels for Tactical Shelters.” The above-identified provisional patent application is hereby incorporated by reference in its entirety.

### FIELD OF THE INVENTION

The present invention relates to blast resistant panels. In one embodiment, the present invention relates to blast resistant panels that are designed for use in a tactical shelter. In another embodiment, to reduce the weight of a tactical shelter, a lightweight panel system is disclosed herein.

### BACKGROUND OF THE INVENTION

Recent United States and multi-national military missions have demonstrated the need for a shelter system that is cost effective and light-weight yet still delivers a high performance tactical shelter system that can protect the lives of personnel in a high risk environment and are also capable of deflecting the energy associated with electro-magnetic radiation. Also of interest is a tactical shelter systems that can protect strategic and high cost military and tactical assets within a high risk environment, where such tactical shelters are also capable of deflecting the energy associated with electro-magnetic radiation. Current shelter systems generally suffer from a weight penalty that can, in some circumstances, prohibit their installation.

Thus, in view of the above, a sheltering system would be able to accommodate more personnel protection schemes if such a system were lightweight, possessed a high blast resistance, possessed a secondary fragmentation impact resistance, and/or were cost effective panels were available to be utilized within such shelter systems. Accordingly, there is a need in the art for light-weight and/or cost-efficient panels that possess, among other advantages, better blast resistance and secondary fragmentation protection.

### SUMMARY OF THE INVENTION

The present invention relates to blast resistant panels. In one embodiment, the present invention relates to blast resistant panels that are designed for use in a tactical shelter. In another embodiment, to reduce the weight of a tactical shelter, a lightweight panel system is disclosed herein.

In one embodiment, the present invention relates to a blast resistant panel comprising: a powder-filled sandwich layer having a first face and a second face, the powder-filled sandwich layer comprising a facing layer and a first backing layer separated by a layer of powder placed between the facing layer and the first backing layer; a first cladding layer having a first surface and a second surface, the first surface of the first cladding layer being in contact with the second face of the powder-filled sandwich layer, wherein the first cladding layer is formed from a combination of a first crushable core layer and a second backing layer; and a second cladding layer having a first surface and a second surface, the first surface of the second cladding layer being in contact with the second face of the first cladding layer, wherein the second cladding layer is formed from a combination of a second crushable core layer and a third backing layer.

In another embodiment, the present invention relates to a blast resistant panel comprising: a sand-filled sandwich layer having a first face and a second face, the sand-filled sandwich layer comprising a facing layer and a first backing layer separated by a layer of powder placed between the facing layer and the first backing layer; a first cladding layer having a first surface and a second surface, the first surface of the first cladding layer being in contact with the second face of the sand-filled sandwich layer, wherein the first cladding layer is formed from a combination of a first crushable core layer and a second backing layer; and a second cladding layer having a first surface and a second surface, the first surface of the second cladding layer being in contact with the second face of the first cladding layer, wherein the second cladding layer is formed from a combination of a second crushable core layer and a third backing layer, wherein each of the first and second crushable core layers are independently formed from a metal material, metal alloy material, a carbon-fiber material or a combination of two or more thereof.

### BRIEF DESCRIPTION OF THE DRAWINGS

FIG. 1 is a photograph and cross-sectional illustration of a design for a blast panel in accordance with one embodiment of the present invention, where the photograph shows how a tactical shelter can be formed from the panels of the present invention;

FIG. 2A is a cross-sectional illustration of a design for a blast panel in accordance with another embodiment of the present invention;

FIG. 2B is a cross-sectional illustration of the blast panel of FIG. 2A after impact;

FIG. 3 is a graph depicting the minimum shielding effectiveness requirements per ASTM E1925;

FIG. 4 is a flow chart illustrating a design optimization process for a blast panel according to the present invention;

FIGS. 5A and 5B are photographs that depict some of the possible testing setups that are used to confirm the blast resistance of blast panels formed in accordance with the present invention; and

FIG. 6 is an illustration of a three-station high-speed camera system for capturing a blast impact process of a blast panel formed in accordance with the present invention.

### DETAILED DESCRIPTION OF THE INVENTION

The present invention relates to blast resistant panels. In one embodiment, the present invention relates to blast resistant panels that are designed for use in a tactical shelter. In another embodiment, to reduce the weight of a tactical shelter, a lightweight panel system is disclosed herein.

Various honeycomb types of sandwich structures with different facings have been used in the past in existing shelter systems (Department of Defense standard family of tactical shelters—2000). However, to date blast resistant panels have failed to yield satisfactory secondary fragmentation impact resistance since certain design criteria have not been considered. To address the problem of absorbing the secondary fragmentation energy, a new multilayer sandwich panel design is disclosed in the present invention.

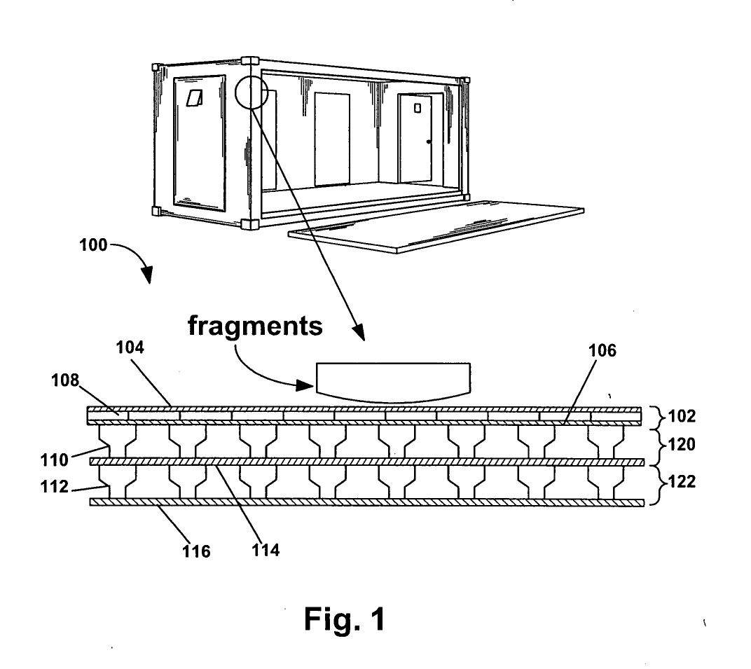

In one embodiment of the present invention, a panel according to the present invention comprises at least three layers, with a frontmost layer (i.e., the layer on the external surface of the panel) being formed from a sandwich layer that contains therein sand, or some other type of impact dissipating powder, and at least two cladding layers that are formed from a lightweight metal material (see FIG. 1). In this embodiment, the sand-filled sandwich layer is formed from two lightweight metal layers, or: metal alloy layers, that contain therebetween a sand layer.

Also in this embodiment, each of the cladding layers comprise a backing layer in combination with a cladding core, where the cladding core faces towards the external surface of the panel and is designed to be crushable under a given amount of impact force. In this embodiment, suitable lightweight metal materials for use in forming the sandwich layer, as well as the at least two cladding layers include, but are not limited to, aluminum, titanium, stainless steel, alloys thereof, or a combination of two or more thereof.

In another embodiment of the panel structures of FIG. 1, the two or more cladding core structures can be, for example, made of a lightweight metal or some other type of crushable composite material that can be suitably bonded, or attached, to the metal backing layers to yield the above-mentioned two or more cladding layers.

Where the cladding core structures are formed from a suitable lightweight metal material (e.g., aluminum), or a suitable composite material, the energy from a first blast wave is substantially dissipated through core crushing. Meanwhile, the sand-filled sandwich layer can, in one embodiment, have a cellular structure, thereby being designed to slow and/or catch projectiles, or pieces thereof, generated by secondary fragmentation impact (see FIG. 1). In this embodiment, the use of at least two backing layers in combination with their respective cladding cores improves the stability of the panel and increases the energy absorption capacity of such a panel.

In one embodiment, the density of the powder or sand in the powder-filled, or sand-filled, sandwich layer is in the range of about 1.4 to about 1.6 g/cc. In one instance,. such a sand density is less than the density of an aluminum alloy that can be used to form all of, or part of, the remaining at least two cladding layers. In one embodiment, the sand in the sand-filled sandwich layer of the present invention can be placed there at the time of manufacture, or even after manufacturing is completed (e.g., in the “field”).

The three-sandwich-layer hybrid panel system of FIG. 1 of the present invention utilizes a novel structural design for a blast resistant panel thereby yielding, among other things, a blast resistant panel that is lightweight while having improved blast and secondary fragmentation resistance. Another advantage of the blast resistant panels in accordance with the present invention is that such panels possess a high energy absorption capability.

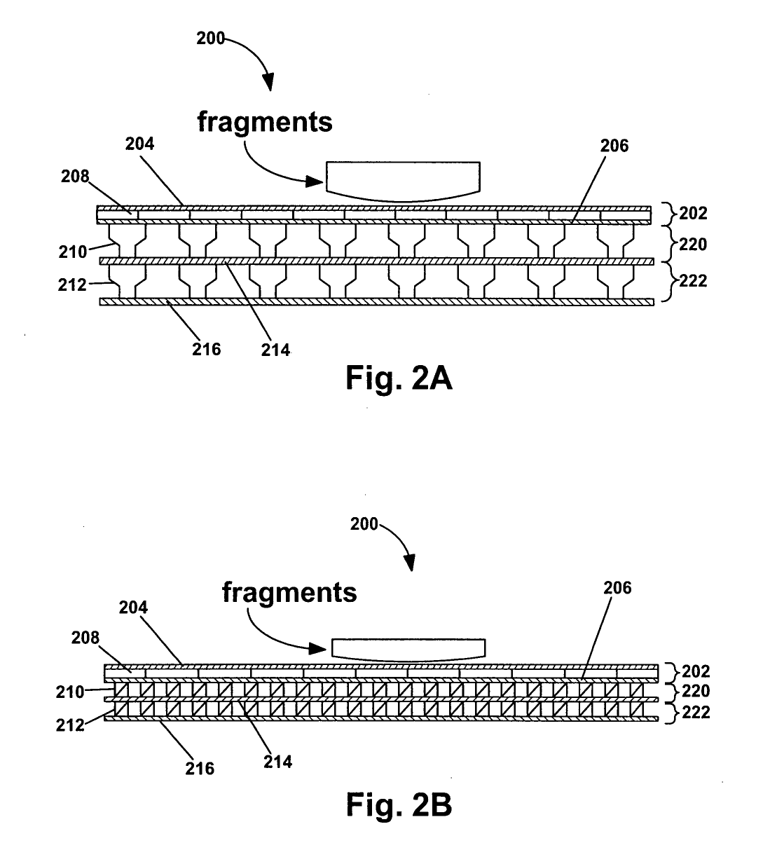

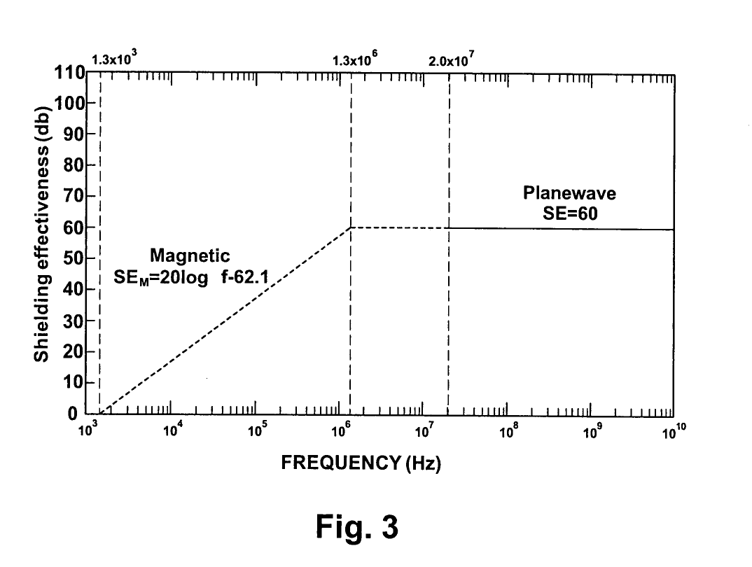

In another embodiment of the present invention, a panel according to the present invention comprises three layers, with a frontmost layer (i.e., the layer on the external surface of the panel) being formed from a sandwich layer that contains therein sand, or some other type of impact dissipating powder, and at least two cladding layers that are formed from a lightweight composite material (see FIG. 2A). In this embodiment, the sand-filled sandwich layer is formed from two composite layers, or laminated composite layers, that contain therebetween a sand layer.

Also in this embodiment, each of the cladding layers comprise a composite, or laminated composite, backing layer in combination with a cladding core, where each cladding core faces towards the external surface of the panel and is designed to be crushable under a given amount of impact force. In one embodiment, the two or more cladding cores can be formed from suitable lightweight metal materials that include, but are not limited to, aluminum, titanium, stainless steel, alloys thereof, or a combination of two or more thereof. In another embodiment, the metal-based cladding cores of this embodiment can be replaced in whole, or in part, by crushable composite structures. Suitable crushable composite structures include, but are not limited to, graphite or carbon-fiber based crushable structures, or other crushable structures formed from the composite, or laminated composite materials described below.

As would be apparent to those of skill in the art, the sandwich layers for use in the sand-filled sandwich layer can be formed from any suitable combination of metal or composite material. The materials suitable for use in the sandwich layers of the sand-filled sandwich layer are identical to those materials described above with regard to the backing layers of the two or more cladding layers.

The materials used for the two or more backing layers, or even for use in the sandwich layers of the sand-filled sandwich layer, can be independently selected from ceramic layers, plastics, glass-filled plastics, fiber-reinforced composite layers, or other types of composite layers described below.

Fiber-reinforced composites are advantageous in that they are lightweight, high in strength, have high stiffness to weight ratios, and possess the ability to absorb a high amount of energy (i.e., high energy absorption). The ability of a composite to absorb a large amount of energy (e.g., impact energy) is primarily determined by the nature of the reinforcing fibers. In one embodiment, the present invention utilizes fiber systems with good ballistic and/or impact performance. These include glass (S- and R-glass), aramid (commercial name KEVLAR® or TWARON®), high performance polyethylene (HPPE) (commercial name SPECTRA® or DYNEEMA®), polybenzoxazole (PBO), M5 fibers formed from polypyridobisimidazole, or combinations of two or more thereof.

Besides the type of fibers used to form the fiber-reinforced backing layers, the fiber architecture can also play a role in energy absorption and ballistic/impact protection. Braided composites possess excellent damage tolerance (see Roberts, G. D., Pereira, J. M., Revilock, D. M., Binienda, W. K., Xie, M., and Braley, M., Ballistic impact of braided composites with a soft projectile, NASA/TM-2004-212973 (2004)); whereas chain composites can undergo large deformations thereby leading to high impact energy absorption (see Cox, B. N., Sridhar, N., Davis, J. B., Mayer, A., McGregor, T. J., and Kurtz, A.G., Chain composites under ballistic impact conditions, International Journal of Impact Engineering, Vol. 24, 809-820 (2000)).

Accordingly, in one embodiment of the present invention a panel in accordance with the present invention utilizes one or more sandwich layers and/or backing layers selected independently from laminated composites, chain composites, braided composites, a combination of chain and braided composites, or a hybrid composite utilizing two or more of the above composite types. The use of such composites in combination with suitably designed cladding cores and a sand-filled sandwich layer permits the manufacture of blast resistant tactical panels with improved ballistic and/or impact protection properties.

Based on the above, the following five types of composites are within the scope of the present invention and are used to form/manufacture tactical panels in accordance with the present invention.
(1) Conventional laminates: these types of composite materials are known to those of skill in the art and are generally used as the backing plate layer in the composite armors of the present invention.
(2) Hybrid composite materials: glass fibers in combination with other high performance fibers such as PBO and M5 fibers, yield composite materials having excellent performance both in structural efficiency and energy absorption.
(3) Stitched composites: stitched composites can be used to contain the damage induced by ballistic impact loading.
(4) Braided composites: braided composites can tolerate a significant amount of damage caused by a ballistic impact (see Roberts, G. D., Pereira, J. M., Revilock, D. M., Binienda, W. K., Xie, M., and Braley, M., Ballistic impact of braided composites with a soft projectile, NASA/TM-2004-212973 (2004)). The present invention utilizes braided composites such as, but not limited to, quasi-isotropic tri-axial braided composites (e.g., 0°/±60°) (see Binienda, W. K., High energy impact of composite structures—Ballistic experiments and explicit finite element analysis, Report, submitted to NASA Glenn Research Center, The University of Akron, Akron, Ohio (2004)) to, among other things, improve the multi-hit capability of an armor designed in accordance with the present invention.
(5) Chain composites: chain composites are a new class of composites with exceptionally high specific energy absorption capacity under tensile loading (much higher than conventional composites). Accordingly, the present invention utilizes these composites to increase the energy absorption ability of armor designed in accordance with the present invention.

Additional information with regard to the above composites can be found in co-pending U.S. patent application Ser. No. 11/437,254, entitled “Hybrid Composite Structures for Ballistic Protection,” filed May 19, 2006, which is hereby incorporated by reference in its entirety.

Besides the above viable composites, aluminum foam can also be used as a backing layer. In this embodiment, the backing layers are sandwich-type layers formed from a center of aluminum foam that is placed between two thin layers of a suitable metal or composite material. The structure of the backing layers of this embodiment are similar in nature to the sand-filled sandwich layer described above.

The three layer panel system of the present invention (see FIGS. 1 and 2) utilizes a novel structural design for a blast resistant panel thereby yielding, among other things, a blast resistant panel that is lightweight while having improved blast and secondary fragmentation resistance. Another advantage of the blast resistant panels in accordance with the present invention is that such panels possess a high energy absorption capability.

Various exemplary embodiments will now be discussed for a blast resistant panel according to the present invention. It should be noted that the present invention is not solely limited to just these exemplary embodiments. Rather, all equivalents that would be apparent to those of skill in the art are also meant to be encompassed by the following disclosure.

Turning to FIG. 1, a panel 100 in accordance with embodiment of the present invention is illustrated. Panel 100 comprises a frontmost sand-filled sandwich layer 102 in combination with at least two cladding layers 120 and 122. With regard to frontmost sand-filled sandwich layer 102, layer 102 is, in one embodiment of the present invention, a combination of a sand layer 108, and a facing layer 104 and a backing layer 106. Sand 108 can be filled in the cellular box core of the sand-filled sandwich layer either during the fabrication process or during the shelter installation/assembly process. In this embodiment, as well as other embodiments disclosed herein, the material used for facing layer 104 and backing layer 106 can independently be chosen from suitable metals, metal alloys, composites, laminated composites, or a combination of two or more thereof. As is noted above, suitable metals and/or metal alloys include, but are not limited to, aluminum, titanium, stainless steel, alloys thereof, or a combination of two or more thereof.

As is noted above, panel 100 comprises at least two cladding layers 120 and 122 which are each individually formed from a crushable cladding core (110 and 112) in combination with a backing layer (114 and 116, respectively). In this embodiment, cladding cores 110 and 112, as well as backing layers 114 and 116, are formed from a suitable lightweight metal, or metal alloy. In this embodiment, cladding cores 110 and 112, as well as backing layers 114 and 116, can be independently formed from suitable metals and/or metal alloys that include, but are not limited to, aluminum, titanium, stainless steel, alloys thereof, or a combination of two or more thereof.

Cladding cores 110 and 112 in the at least two cladding layers 120 and 122, respectively, are designed to resist a blast wave and to increase energy absorption. The thickness of each of cladding cores 110 and 112 can be chosen independently and is not limited to any specific range of thicknesses. Rather, cladding cores 110 and 112 can be independently designed to be any suitable thickness depending upon the degree of blast resistance desired.

In the multilayer sandwich design for a blast resistant panel as shown in FIG. 1, the blast protection capability of a shelter panel 100 in accordance with one embodiment of the present invention can be achieved by reflecting the blast wave and absorbing the kinetic energy of the blast wave through plastic deformation or a fracture process. Secondary fragmentation protection capability by panel 100 shown in FIG. 1 is achieved as a result, in this embodiment, of sand-filled sandwich layer 102 that is formed from facing layer 104 and backing layer 106.

In this embodiment, a blast resistant panel design for a composite tactical shelter generally requires that the components of the shelter/structure have excellent impact resistance, high energy absorption, as well as remain lighter weight for installation efficiency. Thus, in one embodiment, blast resistant panels 100 in accordance with this embodiment of the present invention have a thickness in the range of about 0.75 to about 5 inches, or even from about 1 to about 3 inches.

Turning to FIG. 2A, the embodiment of FIG. 2A is similar to that of FIG. 1 except that each of the facing and backing layers of the embodiment of FIG. 1 are independently selected from a suitable composite material. Suitable composite materials for use in this embodiment are described above in detail.

Specifically with regard to FIG. 2A, a panel 200 in accordance with another embodiment of the present invention is illustrated. Panel 200 comprises a frontmost sand-filled sandwich layer 202 in combination with at least two cladding layers 220 and 222. With regard to frontmost sand-filled sandwich layer 202, layer 202 is, in one embodiment of the present invention, a combination of a sand layer 208, and a facing layer 204 and a backing layer 206. Sand 208 can be filled in the cellular box core of the sand-filled sandwich layer either during fabrication process or during the shelter installation/assembly process. In this embodiment, as well as other embodiments disclosed herein, the material used for facing layer 204 and backing layer 206 can independently be chosen from suitable composites, or laminated composites, as are discussed above.

As is noted above, panel 200 comprises at least two cladding layers 220 and 222 which are each individually formed from a crushable cladding core (210 and 212) in combination with a backing layer (214 and 216, respectively). In this embodiment, cladding cores 210 and 212, as well as backing layers 214 and 216, are formed from a suitable lightweight metal, metal alloy, or composite material. In this embodiment, cladding cores 210 and 212 can be independently formed from any suitable metal and/or metallic alloy that can be joined to backing layers 214 and 216. Such suitable materials include, but are not limited to, aluminum, titanium, stainless steel, alloys thereof, or a combination of two or more thereof.

Cladding cores 210 and 212 in the at least two cladding layers 220 and 222, respectively, are designed to resist a blast wave and to increase energy absorption. The thickness of each of cladding cores 210 and 212 can be chosen independently and is not limited to any specific range of thicknesses. Rather, cladding cores 210 and 212 can be independently designed to be any suitable thickness depending upon the degree of blast resistance desired.

In the multilayer sandwich design for a blast resistant panel as shown in FIG. 2A, the blast protection capability of a shelter panel 200 in accordance with one embodiment of the present invention can be achieved by reflecting the blast wave and absorbing the kinetic energy of the blast wave through plastic deformation or a fracture process. Secondary fragmentation protection capability by panel 200 shown in FIG. 2A is achieved as a result, in this embodiment, of sand-filled sandwich layer 202 formed from facing layer 204 and backing layer 206.

In this embodiment, a blast resistant panel design for a composite tactical shelter generally requires that the components of the shelter/structure have excellent impact resistance, high energy absorption, as well as remain lighter weight for installation efficiency. Thus, in one embodiment, blast resistant panels 200 in accordance with this embodiment of the present invention have a thickness in the range of about 0.75 to about 5 inches, or even from about 1 to about 3 inches.

In still another embodiment, the present invention relates to a blast resistant panel that is the combination of composite materials and lightweight metal materials. In this case, any one or more of the facing and backing layers can be independently selected from any combination of composite, laminated composite, lightweight metal, or lightweight metal alloy material. In this embodiment, the cladding cores can also be independently selected from any combination of composite, laminated composite, lightweight metal, or lightweight metal alloy material.

In one embodiment, the facing and backing layers of the present invention are independently formed from any laminated composite that is lightweight, possesses high strength and stiffness to weight ratios, and a high energy absorption capacity. In one instance, the existence of two cladding cores, each having a backing layer, are for the purpose of providing additional stability to a blast panel in accordance with the present invention.

Thus, the present invention, in various embodiments, utilizes a combination of several material technologies to produce a blast resistant panel as discussed above. In the present invention, these technologies are considered during the design process of a blast resistant panel in order to yield a blast panel that can be used, for example, to construct a shelter having excellent blast and secondary fragmentation impact resistance.

Since the “front” layer of panels 100 and 200 are filled with sand, this layer blunts any incoming projectiles and dissipates the energy associated therewith through the friction produced via the interaction with sand 108/208. Crushable cladding cores 110 and 112, or 210 and 212, are deigned to absorb the kinetic energy associated with an incoming blast wave. During this process, the impact energy is absorbed through two mechanisms: (1) the cladding cores crushing under blasting (see FIG. 2B); and (2) friction/collision of sand 108/208 under fragmentation impacts. Intensive deformation of any one or all of the sandwich layers are desirable in order to absorb energy.

In another embodiment, sand 108/208 can be replaced by any suitable powder material. Such powders include, but are not limited to, ceramic powders, glass powders, metal powders, metallic alloy powders, or combinations of two or more thereof.

In order to properly design a blast resistant panel and/or structure a number of issues must/should be considered. To begin with, the blast and secondary fragmentation impact of a bomb, or other destructive force, on a multi-layered composite shelter structure is a very complex process. To date, no sufficient analysis method has been developed which permits the detailed analysis of the blast and secondary fragmentation impact of a bomb, or other projectile, on a multi-layered shelter panel and/or shelter. Therefore, in another embodiment, the present invention is related to a method for analyzing the data associated with a blast and secondary fragmentation impact of a bomb on a multi-layered shelter panel and/or shelter. FIGS. 2A and 2B illustrate a panel according to one embodiment of the present invention both before and after projectile and/or blast fragment impact (Stage I Impact). After this, a crushed sandwich panel with a sand filled top sandwich layer is analyzed considering a fragmentation impact for Stage II. In Stage II, the fragmentation impact can, if so desired, be treated as impact process of multiple ballistic projectiles. Based on experimental observations using high velocity camera image analysis for an armor system, the ballistic impact mechanism generally involves three major processes: (1) collision, friction and debris of ceramics, which absorb about 45% to about 70% of the kinetic energy of the projectile; (2) erosion and mushrooming of the projectile, which absorb from about 10% to about 15% of the kinetic energy of the projectile; and (3) deformation and failure of the facing and backing face sheets under relative large deformation, with the non-linear behavior as well as the strain rate effect fully developed, which absorb from about 20% to about 40% of the kinetic energy of the projectile. In the theoretical model for designing the new hybrid panels according to the present invention, the governing equations can be obtained through conservation of mass, momentum and energy, and different mechanisms of deflecting fragments will be taken into consideration.

The proposed analytical model of the present invention is able to approximately predict the crushing under blast loading, penetration and perforation under secondary fragmentation ballistic impact, and can be efficiently used in the parametric study and preliminary design analysis. Based on the required protection levels and weight goals (MIL-STD-1472D, MIL-STD-662F; MIL-STD-367A), the three-sandwich-layer blast panels will be designed in accordance with multiple embodiments of the present invention. Multiple embodiments are formed with some of the differences being the thickness of the sand filled front sandwich layer 102, the independently selected thicknesses of facing sheet 104 and backing sheets 106, 114 and 116, the independently selected thicknesses of the cladding layers 118 and 120.

In order to check the blast and secondary fragmentation protection capability of the different blast panel embodiments according to the present invention (see FIG. 1), numerical finite element simulation with LS-DYNA is carried out for a desired panel embodiment based on the above discussion.

The projectile used for the studies of the present invention is a 130 mm Russian howitzer shell that is designed to explode 25 feet away from a shelter built from blast panels made in accordance with one or more of the embodiments of the present invention. From the given condition, the blast wave generated can be simulated using LOAD_BLAST in the FE software LS-DYNA by setting the corresponding equivalent mass of TNT; while the fragments generated by the blasting could be simulated by the software CONWEP. Thus, in one embodiment, the present invention can utilize computer-based modeling to determine the blast resistance of panels designed in accordance with the present invention.

Aluminum facing and backing layers, cladding core and fragments can be modeled as bi-linear elastic-plastic materials by using Material Type3 (MAT_PLASTIC_KINEMATIC), which contains kinematic hardening. Strain rate effect is accounted by using strain rate dependent factor. Laminated composites are modeled by Material Type 22 (MAT_COMPOSITE_DAMAGE) based on Chang-Chang failure criterion, which combines three failure criteria (Schwartz 1984), namely, fiber fracture, matrix cracking, and compressive failure. When the combined stresses reach a critical value, the panel and/or composite panel is deemed to have failed. Sand is modeled by SPH elements (MAT_NULL). The material constants of sand, aluminum facing and backing layers and cladding cores that define the material model in LS-DYNA can be obtained from the existing experimental data (Mayseless et al. 1987; Chocron-Benloulo and Sanchez-Galvez 1998); while the material properties of composites can be obtained through micro/macromechanics analysis.

Four-node shell element is used to model all the proposed facing layers, cladding cores and the fragments. CONTACT_AUTOMATIC_NODES_TO_SURFACE is used to check the interaction between the sand and facing and backing plates used to form the sand-filled sandwich layer. CONTACT_ERODING_SURFACE_TO_SURFACE element is used to describe the interaction between the fragment and the composite panel structure. This element simulates the projectile erosion which is one of the major features of projectile penetration process. Thus, the penetration and perforation of the ballistic impact can be modeled by eroding elements from the fragment surface as well as target structure. LS-DYNA code provides an erosion algorithm through which the erosion process mentioned above can be easily implemented.

In one embodiment, the numerical model is first calibrated with the existing experimental data in literature (Mayseless et al. 1987; Chocron-Benloulo and Sanchez-Galvez 1998) and later with the test data collected from blast panels formed in accordance with the present invention, as is described above. Different fragments at different velocities are simulated as they impact the blast panels of the present invention. During the simulation, the distribution of energy, stresses along the interfaces of different layers of materials, and residual velocity or penetration depth of the projectile is obtained. Once confidence in accuracy of the numerical simulation is achieved, blast and secondary fragment impact simulation and analyses of any design that is based on the structures shown in FIGS. 1 or 2A is carried out.

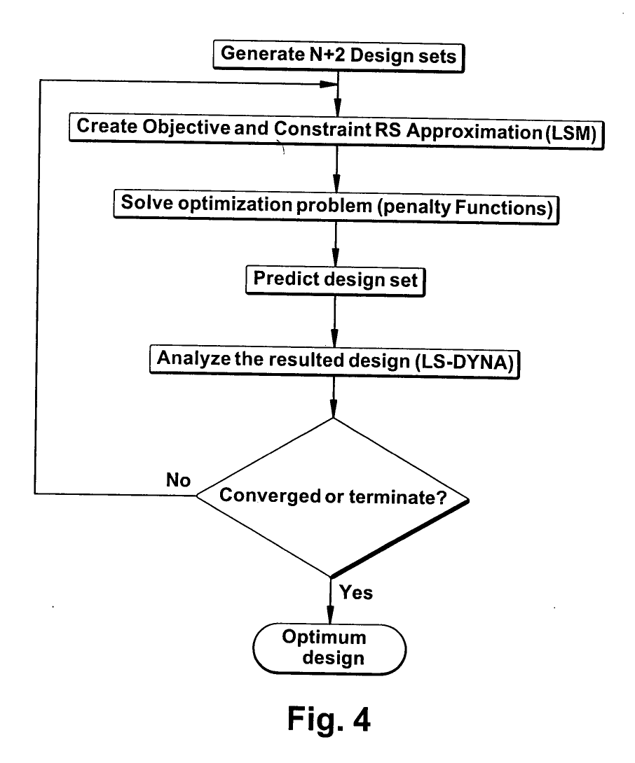

In another embodiment of the present invention, the at least two cladding layers 120 and 122, or 220 and 222, also serve as shields against electromagnetic signals. The electromagnetic energy deflection capability of the sandwich with aluminum or laminate facing and backing layers can be analyzed using the commercial finite element software ANSYS. The advantages and disadvantages of the different sandwich structures can be/are calculated and compared. A four-node fully integrated shell element is used. The material and geometric properties are chosen to be the same as in the blast and impact analysis. The analysis is conducted for two different stages: Stage 1—where the panel design is still structurally intact; Stage 2—where at least two cladding layers 120 and 122, or 220 and 222, have been crushed as a result of an impact thereto. Three frequencies of block magnetic fields in the range of about 100 kHz to about 20 MHz from inside and outside the shelter are chosen for low frequency electromagnetic analysis. Four frequencies of plane wave fields in the range of about 300 MHz to about 10 GHz in accordance with Test Method E1851 are chosen for high frequency electromagnetic analysis. As is shown in FIG. 3, the calculated effectiveness is compared with the required minimum shielding effectiveness specified by ASTM E1925 in the range of 100 kHz to 10 GHz.

The tools available today to accurately estimate the Shielding Effectiveness (SE) of the shelter are theoretical analysis, experimental measurement and numerical simulation. In one instance, ANSYS is used to analyze the shielding effectiveness and compare with experimental measurements. There are two ways to excite the shelter, i.e., external source mode and internal source mode. In the external source model, the shelter is excited by an external EM (Electromagnetic) plane wave source. The induced current I is monitored at the center of the shelter (shielded current). To determine the minimum shielding, it is necessary to simulate all angles of incidence (α=0. . . 360°). In one embodiment, a 30° angle interval is used. In order to calculate the SE, the induced current I_{ref} at the measurement station with the shelter removed (reference current) is also needed. In the internal source model, an equivalent EM generator at the center of the shelter is used. The advantage of the internal source model is that the radiation can be found for all directions in a single computation. Electric and magnetic fields are monitored at numerous points outside the shelter.

In the external source model, the SE in each direction is calculated by Equation (1) shown below:

$$SE ( f ) = - 20 {Log}_{10} ( \frac{I ( f )}{{I}_{ref} ( f )} ) \qquad ( 1 )$$

where /(f)and E_{ref}(f)are the induced currents due to a plane wave incident in each direction. Similarly, in the internal source model, the SE is calculated by Equation (2) shown below:

$$SE ( f ) = - 20 {Log}_{10} ( \frac{E ( f )}{{E}_{ref} ( f )} ) \qquad ( 2 )$$

where E(f) and E_{ref}(f) are external fields radiated in each direction.

Based on the numerical simulations conducted above, a design optimization approach can be established, which is then be used to obtain the optimal design parameters of the blast and secondary fragmentation protection systems described in the present invention.

A design optimization problem of blast and secondary fragmentation protection structure can be formulated as shown below in Equation (3):
Min: z(x)=ρ_{ƒ}h_{ƒ}+ρ_{c}h_{c}+ρ_{b}h_{b}+ρₛhₛ
Subjected to: U_{P}(x)−U_{T}(x)≦0 (3)
hᵢₗ≦hᵢ≦hᵢᵤ, (i=1, 2, 3, 4)
In this problem, the objective function z(x) is the area density of the panel (which is directly related to the weight of the shelter panel), where x={x₁, x₂, x₃, x₄} ={h_{f}, h_{c}, h_{b}, hₛ}. h_{f}, h_{c}, h_{b}, and hₛ are the thickness of the facing layer, the cladding cores, the backing layers, and the sand, respectively. ρ_{f}, ρ_{c}, ρ_{b}, ρₛ are the density of the facing layer, the cladding cores, the backing layers and the sand, respectively. hᵢₗ and hᵢᵤ are the lower and upper bounds on design variables hᵢ; U_{P}(x) is the displacement of a reference point at the back face of the projectile; while U_{T}(X) is the distance from the back face of sandwich layer two to the reference point. U_{P}(x)−U_{T}(x) gives the penetration distance of the projectile. To successfully contain the projectile, U_{P}(x)−U_{T}(X) must be less than zero. In order to avoid computationally-intensive impact analysis, the objective and constraint functions of above optimization problem will be approximated by their Response Surface (RS) approximation using Least-Square Method (LSM) as shown below in Equation (4):

$$y ( x ) = {a}_{0} + {\sum }_{n = 1}^{N} {a}_{n} {x}_{n} + {\sum }_{n = 1}^{N} {b}_{n} {x}_{n}^{2} + {\sum }_{m = 1}^{N - 1} {\sum }_{n = m + 1}^{N} {c}_{mn} {x}_{m} {x}_{n} \qquad ( 4 )$$

where N is the constraint number and a, b, and c are the coefficients to be determined.

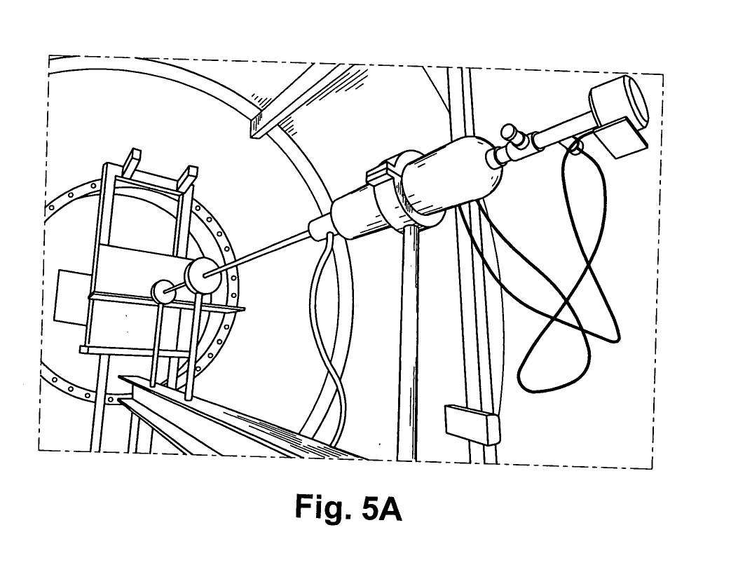

The optimization process is outlined in the flow chart of FIG. 4 in which N+2 design sets will be generated and analyzed at first to construct a linear approximation. The analysis results will then be used to create RS approximation through LSM. Consequently, the optimization problem of Equations (3) and (4) is solved, and the resultant optimum solution is verified by LS-DYNA. If the predicted objective and constraints are identical with the results from LS-DYNA or the estimated optimum is satisfied enough, the optimization loop is stopped. Otherwise, the newly calculated results are added to the design sets and a new optimization process is carried out until the optimal solution is obtained.

A total of two composite panel systems with different facing and backing layer combinations (FIG. 1 or 2A) are evaluated in this manner. The composite panels designed with a sand-filled front sandwich layer are evaluated first. Besides comparing the performance differences of aluminum facing and backing layers versus composite laminated facing and backing layers, the cost of the design are taken into consideration. Each design has different blast and secondary fragment protection capability, weight, cost of materials, and manufacturing process, etc., and their effectiveness is strictly judged by meeting the protection level and weight requirements as specified for the conventional tactical shelter panels. A multi-objective optimization process (Davalos, Qiao and Barbero 1996) is conducted to choose the best panel design for a given application/intended use. Based on the analytical and numerical simulation results yielded by the present invention, design guidelines and recommendation for blast resistant panels in accordance with the present invention are generated. By taking the advantages of a numerical simulation and optimization processes, a significant reduction in cost of full-scale testing can be achieved, avoiding expensive experimental parametric screening/selection of potential shelter panels.

Once a suitable blast resistant panel and/or shelter design has been selected, several available fabrication techniques can be used to produce the desired panel. As would be appreciated by those of ordinary skill in the art, the present invention is not limited to any one particular fabrication method. Rather, any suitable fabrication process can be utilized so long as the fabrication process permits the formation of a blast resistant panel in accordance with the desired design.

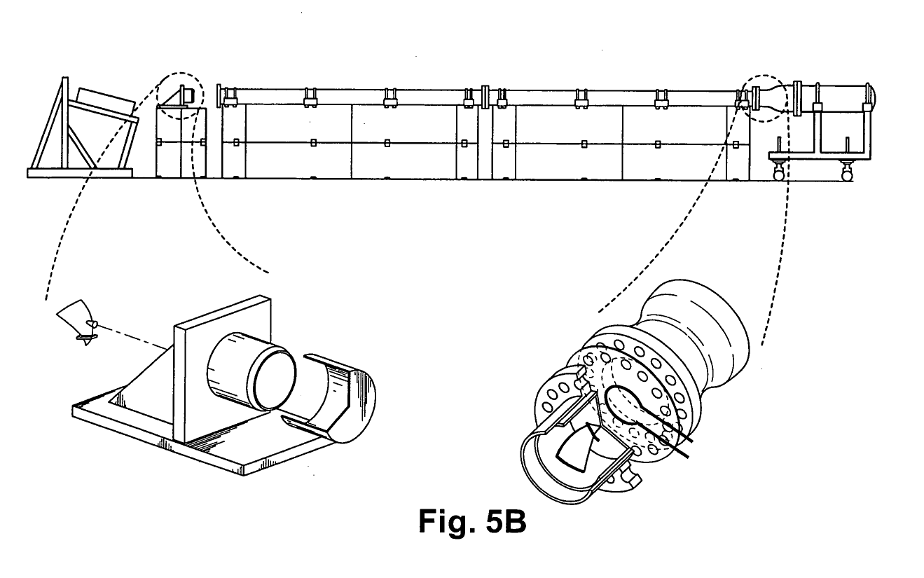

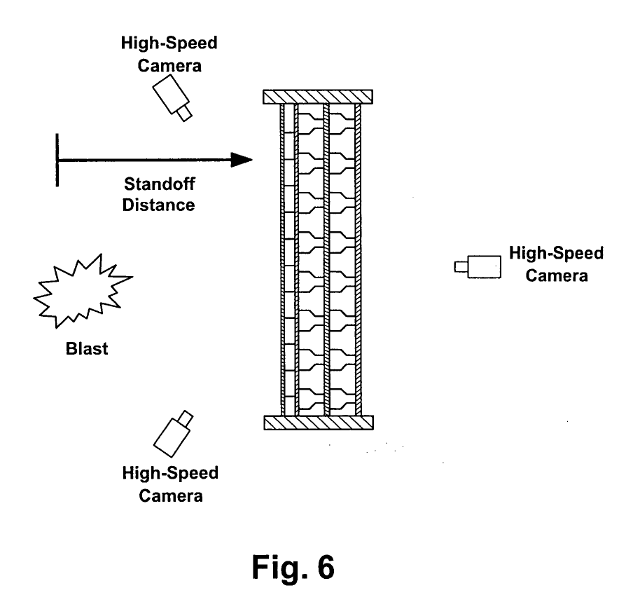

In one instance, several small composite panel samples (in minimum dimensions of 4 foot by 8 foot by 2 inches) are fabricated. To validate the blast resistant panel designs of the present invention, blast and secondary fragment impact experiments are carried out using a blast test (see FIG. 6), a gas gun test (see FIG. 5), and a multi-station high velocity camera (see FIG. 6). The high velocity blast photos are taken at a controlled frequency and used in image analysis (photogrammetry) to capture the displacement and stress history of a design under the test conditions. The failure modes of the cladding layers and mushrooming of sand and/or ceramic powders are studied. The deformation pattern, as well as the failure modes of the at least two backing layers 114 and 116 (or 214 and 216), are studied based on multi-station image analysis (see FIG. 6). The mechanism of image analysis from the multi-station high speed camera is based on the photogrammetry, which is well developed and has been used for measuring deformations as well as velocities of high-speed moving objects. Through the multi-station photogrammetry (see FIG. 6), the trace of the impacted fragment can be reconstructed and checked with the numerical methods used in modeling the blast and secondary fragment impact process.

More importantly, through the preliminary and lab-level blast and secondary fragmentation impact experiment, the effectiveness of the proposed shelter panel systems will be strictly judged by their ability to reflect the blast wave and stop the fragments at the following protection levels modified from the military standards (MIL-STD-662F; MIL-STD-367A):

(a) Blast Protection Level: 130 mm Russian howitzer shell exploded 25 feet away from the shelter.

(b) Fragment Impact Protection Level: 7.62×51 mm shell fragment; velocities up to 500 ft/sec; 0° obliquity angle; goal of less than 4.5 lb/ft².

The proof test will strictly follow the procedures outlined in MIL-STD-662F and MIL-STD-367A, and the composite shelter panel test data report will be provided. The selected panel candidates should be capable of stopping the projectiles at the above protection levels and weight requirements.

To verify potential panel designs in accordance with the present invention, the electromagnetic shielding effect of the tactical shelters should be/are tested in accordance with Test Method E1851. Guided by the numerical study discussed above, a test is conducted at the following fields and frequency ranges. Three frequencies of block magnetic fields in the range of about 100 kHz to about 20 MHz are installed inside and outside the tactical shelter, and the shielding effectiveness is calculated and compared with the minimum shielding effectiveness specified in FIG. 3. Four frequencies of plane wave fields in the range of about 300 MHz to about 10 GHz in accordance with the Test Method E 1851 are also be tested and compared with the minimum shielding effectiveness specified in FIG. 3.

To be able to perform such measurements, a physical realization of the shelter must be built by following the same dimensions as in the designed model. The test method uses a delta measurement of the external field strength due to an EM source in free space and the external field strength of the same EM source placed inside the shelter. Position of the EM source inside the shelter is chosen, in one embodiment, to be arbitrarily in the center.

The experimental setup requires a spectrum analyzer. Measurements are taken using the spectrum analyzer for different EM sources at different frequencies. For each frequency the EM source is rotated 360° and the maximum field strength is noted. Since this is a delta measurement, for these measurements to be valid, no displacement or change to the setup and EM environment is made, except for the shelter presence. The shielding effectiveness can then be calculated using Equation (1) or Equation (2).

As discussed above, lightweight and high energy absorption of blast resistant panels are critical in a tactical shelter system for protection of military personnel and high cost assets. The existing design standard for tactical shelter systems do not take secondary fragment impacts into consideration, which may lead to catastrophic accidents. Although ceramic facing plates have been used in armor systems for a couple of years, the present invention utilizes novel and non-obvious blast panel designs to yield panels that are able to withstand secondary fragment impacts. In one embodiment, the present invention utilizes a sand-filled sandwich layer 102, or 202, to absorb the kinetic energy associated with, for example, projectile fragments through collision and friction of sand particles. In one embodiment, the present invention also blunts the projectile fragments and dissipates the load therefrom over a wide area. The fiber-reinforced composite and/or aluminum backing layers slow and catch the projectile fragments or pieces of fragments until the backing layers exceed their tensile strength and fail.

To reduce the weight associated with panels in accordance with the present invention, at least two cladding layers are, in one embodiment, used instead of the classic metal foam or honeycomb core. The cladding layers of the present invention are also very efficient in producing a blast panel that has a high survivability when exposed to a blast wave. The blast panel designs of the present invention are also good at shielding, blocking and/or dissipating electromagnetic radiation. However, should it be desirable, a metal foam layer or honeycomb layer can be used to replace one or more of the crushable cladding cores of the present invention. In another embodiment, one or more of the backing layers can be replaced by thin metal foam or foam-filled honeycomb structures.

Although the invention has been described in detail with particular reference to certain embodiments detailed herein, other embodiments can achieve the same results. Variations and modifications of the present invention will be obvious to those skilled in the art and the present invention is intended to cover in the appended claims all such modifications and equivalents.

What is claimed is:

1. A blast resistant panel comprising:
a powder-filled sandwich layer having a first face and a second face, the powder-filled sandwich layer comprising a facing layer and a first backing layer separated by a layer of powder placed between the facing layer and the first backing layer;
a first cladding layer having a first surface and a second surface, the first surface of the first cladding layer being in contact with the second face of the powder-filled sandwich layer, wherein the first cladding layer is formed from a combination of a first crushable core layer and a second backing layer; and
a second cladding layer having a first surface and a second surface, the first surface of the second cladding layer being in contact with the second face of the first cladding layer, wherein the second cladding layer is formed from a combination of a second crushable core layer and a third backing layer.

2. The blast resistant panel of claim 1, wherein the powder in the powder-filled sandwich layer is selected from one or more sands, one or more glass powders, one or more ceramic powders, one or more metal or metal alloy powders, or combinations of two or more thereof.

3. The blast resistant panel of claim 1, wherein the powder in the powder filled sandwich layer is sand.

4. The blast resistant panel of claim 3, wherein the density of the sand is in the range of about 1.4 to about 1.6 g/cc.

5. The blast resistant panel of claim 1, wherein the facing layer and each of the backing layers are independently formed from a metal material, metal alloy material, a composite material, a laminated composite material, a plastic material, a glass-filled plastic material, or a combination of two or more thereof.

6. The blast resistant panel of claim 1, wherein the facing layer and each of the backing layers are independently formed from a metal material or laminated composite material.

7. The blast resistant panel of claim 6, wherein the facing layer and each of the backing layers are independently formed from aluminum, stainless steel, titanium, alloys thereof, or combinations of two or more thereof.

8. The blast resistant panel of claim 1, wherein each of the crushable cores layers are independently selected from a metal material, metal alloy material, a composite material, a laminated composite material, a plastic material, a glass-filled plastic material, or a combination of two or more thereof.

9. The blast resistant panel of claim 1, wherein each of the crushable cores layers are independently selected from a metal material or laminated composite material.

10. The blast resistant panel of claim 9, wherein each of the crushable cores layers are independently formed from aluminum, stainless steel, titanium, alloys thereof, or combinations of two or more thereof.

11. A blast resistant panel comprising:
a sand-filled sandwich layer having a first face and a second face, the sand-filled sandwich layer comprising a facing layer and a first backing layer separated by a layer of powder placed between the facing layer and the first backing layer;
a first cladding layer having a first surface and a second surface, the first surface of the first cladding layer being in contact with the second face of the sand-filled sandwich layer, wherein the first cladding layer is formed from a combination of a first crushable core layer and a second backing layer; and
a second cladding layer having a first surface and a second surface, the first surface of the second cladding layer being in contact with the second face of the first cladding layer, wherein the second cladding layer is formed from a combination of a second crushable core layer and a third backing layer,
wherein each of the first and second crushable core layers are independently formed from a metal material, metal alloy material, a carbon-fiber material or a combination of two or more thereof.

12. The blast resistant panel of claim 11, wherein the density of the sand is in the range of about 1.4 to about 1.6 g/cc.

13. The blast resistant panel of claim 1, wherein the facing layer and each of the backing layers are independently formed from a metal material, metal alloy material, a composite material, a laminated composite material, a plastic material, a glass-filled plastic material, or a combination of two or more thereof.

14. The blast resistant panel of claim 1, wherein the facing layer and each of the backing layers are independently formed from a metal material or laminated composite material.

15. The blast resistant panel of claim 14, wherein the facing layer and each of the backing layers are independently formed from aluminum, stainless steel, titanium, alloys thereof, or combinations of two or more thereof.

16. The blast resistant panel of claim 1, wherein each of the crushable cores layers are independently selected from a metal material or laminated composite material.

17. The blast resistant panel of claim 16, wherein each of the crushable cores layers are independently selected from aluminum, stainless steel, titanium, alloys thereof, or combinations of two or more thereof.
